(19) United States
(12) Patent Application Publication
(10) Pub. No.: US 2010/0129779 A1
(43) Pub. Date: May 27, 2010

(54) Image Capture and Tracing System and Method

(76) Inventor: Kevin L. Pomerleau, Carlsbad, CA (US)

Correspondence Address: GEORGE S. LEVY, 3980 DEL MAR MEADOWS, SAN DIEGO, CA, 92130, US

(21) Appl. No.: 12/621,969

(22) Filed: Nov. 19, 2009

Related U.S. Application Data
(60) Provisional application No. 61/117,103, filed on Nov. 22, 2008.

(51) Int. Cl. G09B 11/06

(52) U.S. Cl. 434/88; 434/85

(57) ABSTRACT

This invention is an image capture device for manually transferring an image from a three dimensional scene or from a two dimensional picture onto paper comprised of a two-paneled foldable transparent clipboard. The clip board includes a first panel equipped with a paper clip and a second panel hinged to the first panel. The image capture device also includes a light box and an erasable pen.

This invention claims the benefit of U.S. Provisional Application No. 61/117,103 with the title, “Image Capture and Tracing System and Method” filed on Nov. 22, 2008 and which is hereby incorporated by reference. Applicant claims priority pursuant to 35 U.S.C. Par 119(e)(i). The present invention relates to devices and methods used for capturing three dimensional scenes or two dimensional images by means of tracing on a transparent medium. It also relates to devices and methods used for transferring also by means of tracing, images from a transparent medium onto a sheet of paper.

### FIELD OF THE INVENTION

### Background

Prior art describe several devices and methods that artists can use to capture images manually. In general this prior art falls into two groups. The first group includes methods and devices that employ a transparent sheet located between the artist and the scenery that he wants to capture. To capture the image the artist traces the image that he sees on the transparent sheet. In so doing it is essential that he maintains a fixed point of view to ensure that the image that he sees through the transparency remains stationary with respect the transparency. This prior art group includes U.S. Pat. No. 3,678,589 by R. Baker, U.S. Pat. No. 5,217,376 by Gosselin, U.S. Pat. No. 5,580,250 by McKewen, U.S. Pat. No. 6,785,972 by Goldberg, U.S. Pat. No. D379,371 by Nicholl, and U.S. Pat. No. 9,409 by Richter.

The second group of prior art inventions includes light boxes that allow the user to transfer by tracing an image from a transparent medium onto a sheet of paper. This prior art includes U.S. Pat. No. 2,701,838 by Loesch, U.S. Pat. No. 3,484,952 by Coldren, U.S. Pat. No. 5,217,293 by Kobzeff, U.S. Pat. No. 5,224,770 by Simmons et al, U.S. Pat. No. 7,073,913 by Wa, and U.S. Pat. No. D194,517 by Banks.

None of the prior art combines in an efficient, economical and reliable manner the device for and method of, capturing an image on a transparent sheet, with the device for, and method of, tracing the image from the transparent sheet onto a sheet of paper.

Further features, aspects, and advantages of the present invention over the prior art will be more fully understood when considered with respect to the following detailed description claims and accompanying drawings.

### BRIEF DESCRIPTION OF THE DRAWINGS

FIG. 1 illustrates the invention as it is used to trace a three dimensional scene on a transparent panel.

FIG. 2 shows the construction of the two-panel clipboard onto which images are traced.

FIG. 3 provides a view of the light box with which traced images are transferred onto paper.

FIG. 4 describes the method of use of the invention starting with the capture of the image by tracing it on a transparent panel, flipping the panel to protect the tracing, and then using the light box to trace from the transparent panel onto a sheet of paper.

FIG. 5 illustrates how the two-paneled clipboard can be used to capture a two dimensional image from a book.

FIG. 6 shows how the light box can be used to transfer an image from a transparent panel onto paper.

FIG. 7 illustrates a variation of the alignment sight in an erect and deployed position.

FIG. 7A shows the variation in the design of the alignment sight of FIG. 7 in a horizontal and stowed away position.

### SUMMARY OF THE INVENTION

This invention is an image capture device for manually transferring an image from a three dimensional scene or from a two dimensional picture onto paper comprised of a two-paneled foldable transparent clipboard. The clip board comprises a first panel equipped with a paper clip and a second panel hinged to the first panel. The image capture device also includes a light box and an erasable pen.

This invention can capture images that prior art devices cannot trace because all previous devices require intense back-light. If light cannot traverse an object or if the surface of the object cannot be illuminated then its image cannot be captured. The invention allows the capture of images from walls, pictures, books, TV screens, computer images and more without having light go through the image or item.

Another advantage of this invention is that it allows the user to trace a mirror image of the object by flipping the panels after the image has been captured.

Yet one more advantage of this invention is that an image of an object can be captured and traced without touching the object.

### DETAILED DESCRIPTION

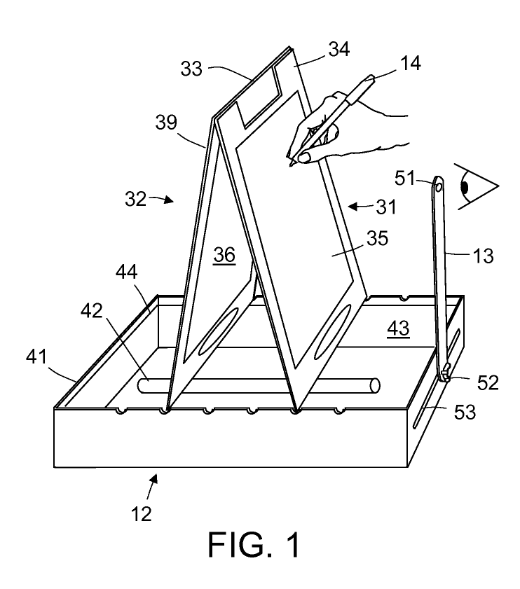

This invented device and its operation are illustrated in FIGS. 1, 2 and 3. The device comprises the following elements:

a) a two-paneled transparent clipboard 11;

b) a light box 12;

c) an aligning sight 13;

d) an erasable pen 14;

Two-Paneled Transparent Clipboard 11

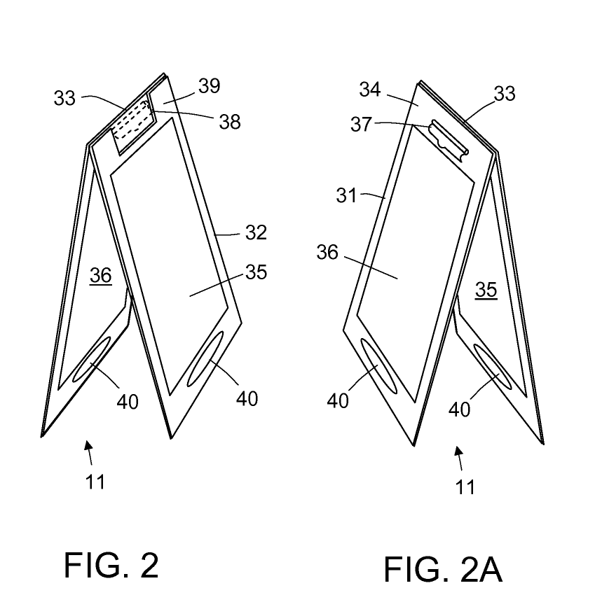

Unlike ordinary clipboards, the two-paneled transparent clipboard 11 shown in FIGS. 2 and 2A comprises two transparent rectangular panels 31 and 32 hinged together at one of their sides. FIG. 2 provides a view from one side and FIG. 2A provides a view from the reverse side. The panels 31 and 32 comprise a plastic frame 34 and 39 respectively which hold the transparent sheets 35 and 36 respectively. These sheets are made of transparent material such as glass or Plexiglas™. The frames 34 and 39 are hinged together along one of their sides, typically, but not necessarily, the smallest side. Both frames 34 and 39 and the hinge 33 can be manufactured as a single piece of plastic.

The clipboard 11 can have two folded configurations, each configurations being fully folded or partially folded as in the shape of a V. The first folded configuration is dubbed the image capture configuration because it is used to capture the image of an object by mans of an erasable pen, for example. The second folded configuration is dubbed the tracing configuration because it is used to trace the image onto a sheet of paper. For explanatory purposes, each side of each panel shall be labeled: the second side of the first panel 32 and the first side of the second panel 31 are defined as being nearest to each other when the clipboard is folded in the image capture configuration; the first side of the first panel 32 and the second side of the second panel 31 are defined as being nearest to each other when the clipboard is folded in the tracing configuration. The folded configuration can be fully folded such that each the panels are in contact with each other, or partially folded such that they form a V.

The hinge 33 could be manufactured as a living hinge. A living hinge is a thin flexible hinge made from plastic that joins two rigid plastic parts together, allowing them to bend along the line of the hinge. It is typically manufactured in an injection molding operation that creates all three parts at one time as a single part. Polyethylene and polypropylene are considered to be the best resins for living hinges, due to their excellent fatigue resistance. It is clearly obvious to anyone versed in the art that other kinds of hinges are possible and this invention is not limited to the living hinge configuration.

One of the panels 32 contains a large paper clip 37 along its hinge side. The other panel 31 is configured with an opening 38 along its hinge side to accommodate the passage of the paper clip 37 when the two panels 31 and 32 are folded together.

The frames 34 and 39 may also include an opening 40 on the side opposite the hinge side to facilitate the handling of the clipboard 11.

Light Box 12

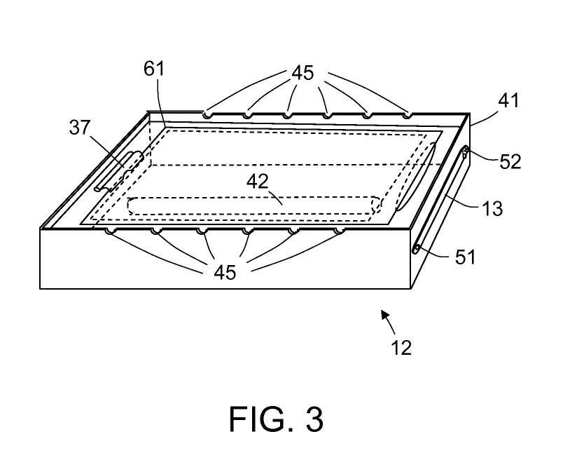

This component is illustrated in FIG. 3. It is comprised essentially of a rectangular box 41, with an open top and equipped inside with a light generation device 42 such as a neon tube. This light generation device 42 can be powered by household current or by batteries to make this device portable outdoors. As shown in FIG. 1, the inside of the light box 12 is lined with a highly reflective coating 43 to maximize the illumination of the light generation device 42. One should note that whereas conventional light boxes are equipped with a fixed transparent cover 44 on their top to hold the original image document and the tracing paper onto which the image is transferred, in this invention, this cover 44 is not essential since the two-paneled transparent clipboard 11 can take its place as shall be described below in the paragraph discussing how the invention is utilized. However, such a fixed transparent cover 44 can be convenient and can be protective of the illumination device 42, and is therefore included as an option in this invention.

The light box 12 is equipped on its long edges with a number of notches 45 to hold the two-paneled clipboard 11. These notches 45 allow the user to select how far from his eyes he can mount the two paneled clipboard 11 as demonstrated in FIG. 1.

Alignment Sight

The light box 12 holds, rotatably and slidably mounted on its side, an alignment sight 13 that allows the user to maintain a fixed perspective with respect the scene which he wants to capture. The sight 13 is essentially a bar fastened at one end to the light box 12 by a butterfly nut 52, and having at the other end an aperture 51 through which the user can observe a scene from a fixed perspective. To utilize the sight 13 the user untightens the butterfly nut 52, slides the sight 13 to a desired position along the slot 53 visible in FIG. 1, and retightens the butterfly nut 52. If the user does not need the alignment sight 13, he can put it back in its original position as shown in FIG. 3. As is evident to those versed in the art, other options exist to fasten this aligning sight to the side of the light box such as VELCRO™ strips and magnets. This aligning sight 13 is not absolutely essential to the invention since the user can always trace a landmark first and then use the trace of the landmark as an aligning sight. The aligning sight 13 is therefore included as an option in this invention.

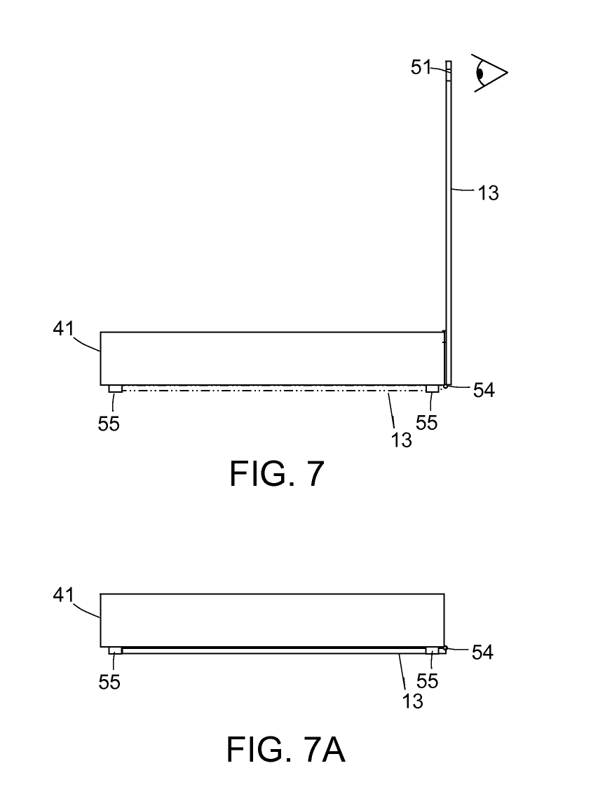

A design variation of the alignment sight 13 is shown in FIG. 7. The sight 13 is a bar hinged to one of the bottom edges of the box 41 by mean of hinge 54. The sight can be deployed as shown in FIG. 7 or stowed away under the box 41 as shown in FIG. 7A. Persons versed in the art will recognize that several means are possible for keeping the sight erect as in FIG. 7. For example, one means is to rely on friction in the hinge. Another means is to use a magnet to latch the sight 13 to the box 41. The magnet can be embedded in the box 41 and the sight 13 can be made of a ferromagnetic metal or contain a ferromagnetic metal. Yet another possible means is to use VELCRO™ strips between the sight 13 and the side of the box 41.

Rubber pad 55 mounted under the box 41 can provide enough space between the box 41 and its supporting surface to accommodate the stowed sight 13. Alternatively this space can be made available by shaping a groove in the bottom of the box in the shape of an inverted U slightly larger in size than the sight 13 and into which the sight can fit when it is stowed away.

Erasable Pen

Since the device is intended to be reusable, tracing could be performed by means of an erasable pen or marker 14. For example, a dry-erase type pen would be very convenient. In such a case, the panel on which the image of the object is captured should be made or coated with a material onto which the ink from an erasable pen can be applied and erased.

Utilization of the Invention

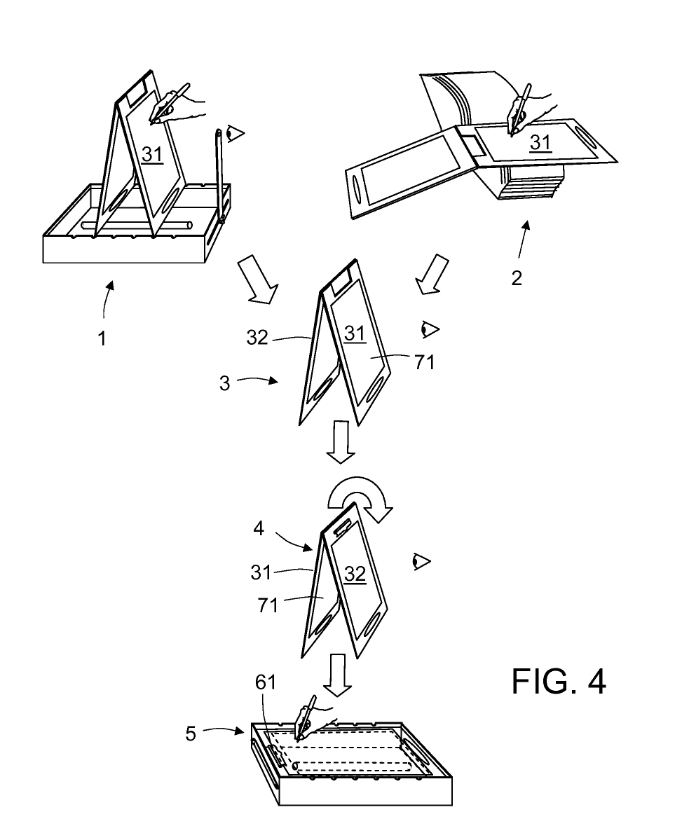

FIG. 4 illustrates the utilization of the invention. The first step 1 is to capture an image on the transparent clipboard 11. If the image to be captured is three dimensional he can use the configuration 1 illustrated in FIG. 4 also shown in FIG. 1 wherein the two-paneled clipboard 11 is erected as an inverted V, on the light box 12, wedged into the notches 45 on the edges of the light box 12. The user can, at his option, use the aligning sight 13 mounted on the side of the light box 12.

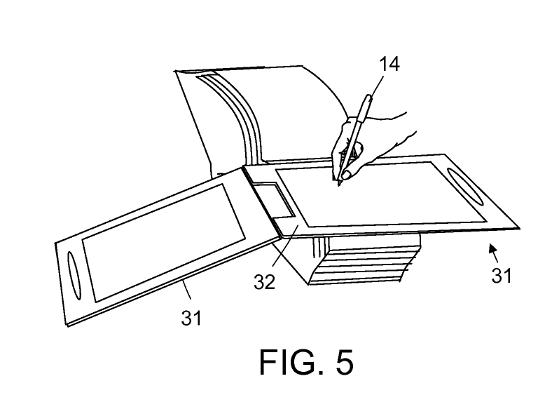

If the image to be captured is two dimensional, the user can use the configuration 2 shown in FIG. 4 as well as in FIG. 5. He positions the panel 31, the one without the clip on top of the image to be traced. The user then traces the image on the panel 31 using the erasable pen 14.

After having traced the image 71, the panel 31 holding the image is facing the user as shown FIG. 4 according to configuration 3.

As illustrated in configuration 4, the user then flips the two-panel clipboard such that the traced image 71 is protected between the two panels as shown in configuration 4 and he is now facing panel 32.

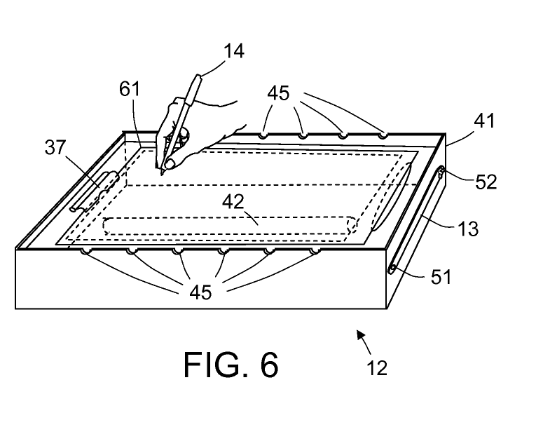

He can, then, as illustrated in FIG. 4 configuration 5 as well as in FIG. 6, place the two-panel clipboard 11 on top of the light box 12, insert a sheet of paper 61 inside the clip 37 and trace on the paper 61 the image drawn on the panel. It is clear that the light box cover 44 shown in FIG. 1 is not essential in this operation. However, as mentioned above, it is included in this invention as an option.

This method of transferring images can transfer images to any object translucent enough to be capable to be traced on such as, but not limited to, paper, fabric and translucent plastic. For example the method could be used to draw on T-shirts. This invention offers several unique ways to copy and trace images as explained in the examples below:

### Example 1

Tracing a picture or image from a book or magazine:
a) taking a photo or image and hold it in place on panel 32 using the provided clip;
b) folding the panel 31 over the photo or image, as to protect it;
c) using a dry-erase pen and trace the image onto panel 31;
d) when your tracing is complete, removing the photo or image from the clip and fold panel 32 over panel 31 so that the traced image is now protected;
e) placing a blank sheet of paper into the clip;
f) placing both clear shields onto the light-box and turning on the light. The image can now be traced on paper or fabric such as a tee-shirt.

### Example 2

Tracing a vertical image from a wall, TV, or hanging object:
a) holding up the panels onto an image/photo on a wall;
b) using the dry-erase pen to trace the image onto panel 31;
c) after the image is traced, folding panel 32 on top of panel 31 to protect the traced image;
d) inserting a sheet of paper into the clip and place the folded clipboard onto the light-box;
e) tracing the captured image onto the paper.

### Example 3

Making landscapes or portraits:
a) Placing the two panels upright as an inverted V onto the light-box by separating them slightly at the unhinged end and using the notches on the edges of the light box to stand them up, thereby forming a transparent easel;
b) maintaining a steady point of reference by using the sight attached to the end of the light-box;
c) tracing an image of anything from a person to a mountain scene on panel 31 using the dry-erase pen;
d) after the image is traced, folding panel 32 on top of panel 31 to protect the traced image;
e) inserting a sheet of paper into the clip and place the folded clipboard onto the light-box;

### Example 4

Creating mirror images or combining more than one picture to create beautiful collages:
a) capturing an image as described in the previous examples;
b) flipping the folded clipboard to provide a mirror image of the image captured on panel 31;
c) clipping a sheet of paper on the back of panel 31. Since in this configuration, the clip 37 is on the wrong side of panel 31, the clip 37 has to be flipped from one side to the other side of panel 31, or an independent clip second clip may have to be used;
d) tracing the image.

### Example 5

Collages or mashups can be generated by capturing several images and tracing the combination on a single sheet of paper.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

I claim:

1. An image capture device for manually transferring an image from a three dimensional scene or from a two dimensional picture onto paper comprised of:
a. a two-paneled foldable clipboard said clipboard comprising:
i. a transparent first panel; and
ii. a transparent second panel;
said first panel and said second panel being articulated along one of their sides by means of a hinge; and
b. a light box.

2. The device as in claim 1 wherein said hinge allows said clipboard to have two folded configurations, each said folded configurations including a fully folded configuration as well as a partially folded configuration as in the shape of a V,
a. first folded configuration being dubbed image capture configuration and used to capture said image; and
b. second folded configuration being dubbed image tracing configuration and used to trace image onto a sheet of paper;
and furthermore, each said panel having a first side and a second side, said second side of said first panel and said first side of said second panel being defined as being nearest to each other when said clipboard is folded in said image capture configuration, and said first side of said first panel and said second side of said second panel being defined as being nearest to each other when said clipboard is folded in said tracing configuration.

3. The image capture device of claim 2 wherein a paper clip is anchored to said second side of first panel along said hinge, thereby allowing the fastening of a sheet of paper to said first panel and furthermore wherein said second panel comprises an opening along said hinge corresponding in location to said paper clip, and configured to allow passage of said paper clip when said panels are in said image capture configuration.

4. The device as in claim 1 wherein said light box is essentially a box with an open top and equipped on its inside with a light source, and also being configured on its edges to support said two-paneled foldable clipboard lying flat on said light box.

5. The device as in claim 4 also comprising a transparent cover fitting over said open top of said light box.

6. The device as in claim 2 wherein said light box is equipped on its top edges with a number of notches configured to hold said two-paneled foldable clipboard erect and folded as an inverted V in said image capture configuration.

7. The image capture device of claim 1 also comprising an alignment sight.

8. The image capture device of claim 7 wherein said alignment sight is in the shape of a bar rotatably and slidably mounted on said light box.

9. The image capture device of claim 1 wherein each said panel is traversed by an opening on the side opposite to said hinge, thereby facilitating the handling of said clipboard.

10. The image capture device of claim 1 also comprising an erasable pen.

11. The image capture device of claim 10 wherein said first panel comprises a material onto which the ink of said erasable pen can be removably applied.

12. A method for a person of capturing the image of an object, which makes use of device of claim 3 comprising:
a. erecting said two-paneled clipboard partially folded as an inverted V in said image capture configuration;
b. tracing said image of said object, as viewed by said person, by means of said erasable pen, on said second side of said second panel;
c. folding said two-paneled clipboard into said fully folded image tracing configuration;
d. clipping a sheet of paper to said second side of said first panel;
e. placing said two-paneled clipboard over said light box;
f. tracing said image onto said sheet of paper.

13. A method as of claim 12 wherein the step of erecting said two-paneled clipboard comprises mounting said two-paneled clipboard on top of said light box using notches configured on the edges of said light box.

14. A method as of claim 12 also including the steps of:
a. deploying a sight;
b. aligning the eye with said object using said sight.

15. A method as of claim 12 to draw on T-shirts.

16. A method as of claim 12 for generating mirror images, also comprising
a. flipping said sheet of paper
b. placing said sheet of paper between folded said two panels
c. flipping said clipboard such that said image appears as a mirror image of itself
d. placing a second sheet of paper on top of said folded clipboard
e. tracing said mirror image on said second sheet of paper.

17. A method for a person of capturing the image of an object and of generating the mirror image of said object, which makes use of device of claim 3 comprising:
a. erecting said two-paneled clipboard partially folded as an inverted V in said image capture configuration;
b. tracing said image of said object, as viewed by said person, by means of said erasable pen, on said second side of said second panel;
c. folding said two-paneled clipboard into said fully folded image tracing configuration;
d. clipping a sheet of paper to said first side of said second panel;
e. placing said two-paneled clipboard over said light box;
f. tracing said image onto said sheet of paper.
